(19) United States
(12) Patent Application Publication
(10) Pub. No.: US 2014/0214890 A1
(43) Pub. Date: Jul. 31, 2014

(54) DATABASE SHARD ARBITER

(71) Applicant: UNICORN MEDIA, INC., Tempe, AZ (US)

(72) Inventor: Matthew A. Johnson, Tempe, AZ (US)

(73) Assignee: UNICORN MEDIA, INC., Tempe, AZ (US)

(21) Appl. No.: 13/755,250

(22) Filed: Jan. 31, 2013

(51) Int. Cl. G06F 17/30

(52) U.S. Cl. CPC G06F 17/30283
USPC 707/770

(57) ABSTRACT

Techniques described herein provide for a shard arbiter to act as an intermediary between querying and/or data-inserting applications and sharded databases. The shard arbiter can provide an interface with which the applications can provide a request (e.g., data insert and/or query) in any of a variety of database languages, and the data is inserted into and/or retrieved from sharded databases without the need for customization or any knowledge of how data is sharded. The shard arbiter can use business rules to determine how data is sharded among databases, and may utilize different types of databases—communicating with each database in its native language.

### BACKGROUND OF THE INVENTION

The ubiquity of networked sensors, computers, mobile devices, and other electronic devices has caused vast increases in the amount of data gathered and stored by these connected devices. These increases can cause many systems to exceed the limits for which databases and other data structures are designed. One way to address this issue is to “shard” the data, partitioning the data among several databases. Such sharding, however, typically involves inflexible customization that requires customized database commands reflecting a knowledge of how the data is sharded.

### BRIEF SUMMARY OF THE INVENTION

Techniques described herein provide for a shard arbiter to act as an intermediary between querying and/or data-inserting applications and sharded databases. The shard arbiter can provide an interface with which the applications can provide a request (e.g., data insert and/or query) in any of a variety of database languages, and the data is inserted into and/or retrieved from sharded databases without the need for customization or any knowledge of how data is sharded. The shard arbiter can use business rules to determine how data is sharded among databases, and may utilize different types of databases—communicating with each database in its native language.

An example method of database request management, according to the description, includes receiving, via a network interface, a database request. The database request comprises a first database command and metadata related to the first database command. The method further comprises determining one or more business rules associated with the database request, based on the metadata, determining, based on the one or more business rules, a plurality of databases related to the database request, and formulating, with a processor, a plurality of database commands based on the one or more business rules. Each database command of the plurality of database commands corresponds with a database of the plurality of databases and is determined based on the first database command. The method also includes, for each database command of the plurality of database commands, sending the database command to the database to which it corresponds.

An example server providing database request management, according to the description, can include a communications interface, a memory, and a processing unit communicatively coupled with the memory and the communications interface. The processing unit is configured to perform functions including receiving, via the communications interface, a database request. The database request comprises a first database command and metadata related to the first database command. The processing unit is also configured to perform functions including determining one or more business rules associated with the database request, based on the metadata, determining, based on the one or more business rules, a plurality of databases related to the database request, and formulating a plurality of database commands based on the one or more business rules. Each database command of the plurality of database commands corresponds with a database of the plurality of databases, and is determined based on the first database command. The processing unit is configured to, for each database command of the plurality of database commands, send, via the communications interface, the database command to the database to which it corresponds.

An example non-transitory computer-readable medium, according to the disclosure, has instructions imbedded thereon providing database request management. The computer-readable medium includes instructions for receiving a database request. The database request comprises a first database command and metadata related to the first database command. The computer-readable medium also includes instructions for determining one or more business rules associated with the database request, based on the metadata, determining, based on the one or more business rules, a plurality of databases related to the database request, and formulating a plurality of database commands based on the one or more business rules. Each database command of the plurality of database commands corresponds with a database of the plurality of databases and is determined based on the first database command. The computer-readable medium also includes instructions for sending, for each database command of the plurality of database commands, the database command to the database to which it corresponds.

Items and/or techniques described herein may provide one or more of the following capabilities, as well as other capabilities not mentioned. As indicated previously, techniques allow an entity to send standard database commands to a shard arbiter that can run the commands against sharded databases, without requiring the entity to have any knowledge of how data is sharded. The shard arbiter can further be database agnostic, receiving database commands in any database language, and working with data shards among different types of databases. These and other embodiments, along with many of its advantages and features, are described in more detail in conjunction with the text below and attached figures.

### BRIEF DESCRIPTION OF THE DRAWINGS

The present disclosure is described in conjunction with the appended figures:

FIG. 1 is a simplified illustration of how shards can be generated from one or more data objects.

FIG. 2 is a block diagram illustrating an example media servicing system configured to deliver media content to a client.

FIG. 3 is a simplified block diagram of a sharding system utilizing a shard arbiter, according to one embodiment.

FIG. 4 is a functional block diagram illustrating various functional features of a shard arbiter, according to one embodiment.

FIG. 5 is a swim-lane diagram illustrating generic interactions between a shard arbiter, a requester, and one or more databases, according to one embodiment.

FIG. 6 is a simplified flow chart illustrating a method of database request management using the techniques described herein, according to one embodiment.

FIG. 7 illustrates an embodiment of a computer system.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Increases in bandwidth associated with data communication networks such as the Internet and increases in the processing power and application functionality of connected devices (servers, computers, mobile devices, etc.) have caused similar increases in the amount of data gathered and stored by these connected devices. This increase in data has caused many systems to exceed the limits for which databases and other data structures are designed, spurring the need for so-called “big data solutions”.

Big data solutions help systems gather, store, and manage data sets that are generally too large to be efficiently processed using traditional data processing applications. As these data sets are becoming increasingly common due to the ubiquity of data-sensing and data-processing devices, the need for such big data solutions becomes increasingly more apparent. Problematically however, big data is difficult to work with using traditional methods, such as relational databases.

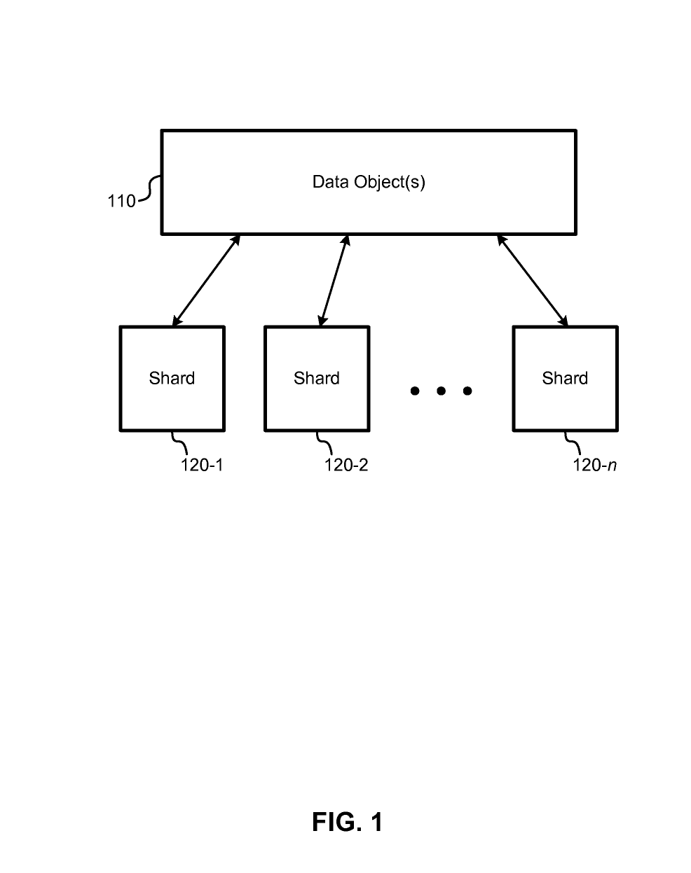

One method of handling a large amount of data that may be too large for a single database to manage is to separate the data into various partitions, called “shards,” and handling the shards separately. FIG. 1 is a simplified illustration of how shards can be generated from one or more data objects 110. Here, the data object(s) 110 can be partitioned, or “sharded,” into n shards. Depending on desired functionality, shards can comprise mutually-exclusive partitions of data that are collectively exhaustive, such that they can replicate the original data object(s) 110 when combined properly. The shards can be managed and stored in separate databases. (As used herein, the term “shard” can refer to a partition of data and/or a database in which the partition is stored. Furthermore, the term “sharded databases” refers to databases storing shards in a sharded data system.) Thus, by partitioning the data object(s) 110 into different shards 120 this manner, each database stores and maintains a manageable portion of the overall data.

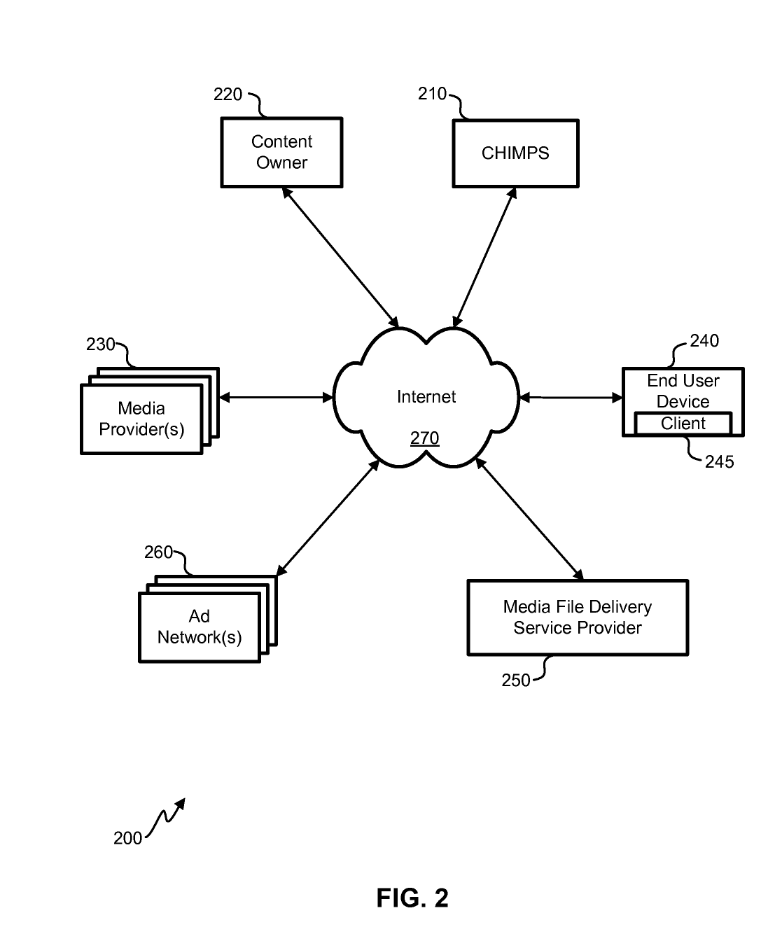

Separating and combining the shards 120, however, can be difficult. Often, such sharding is part of a customized solution in which a requesting entity must make requests (such as data insertion, querying, and/or other data manipulation) using database commands of a particular database language. Additionally, customized solutions often require that the requesting entity has specialized knowledge of the particular methods of sharding and/or the databases in which data shards are located, to allow the requesting entity to separate and/or combine the shards 120 properly. Furthermore, such customized solutions are often limited in the type of databases that may be integrated into the system, and often take significant amounts of rework to integrate new databases into the system. Accordingly, these customized data sharding systems can be problematic in applications in which there might be multiple requesting entities and/or multiple data types. The system of FIG. 2 illustrates an example of one such application in which data sharding can be utilized.

FIG. 2 is a block diagram illustrating a media servicing system 200 configured to deliver media content to a client 245, executed by an end user device 240 providing media playback to an end user. The client 245 can be, for example, a media player, browser, or other application adapted to request and/or play media files. The media content can be provided via a network such as the Internet 270 and/or other data communications networks, such as a distribution network for television content. The end user device 240 can be one of any number of devices configured to receive media over the Internet 270, such as a mobile phone, tablet, personal computer, portable media device, set-top box, video game system, etc. It will be understood that the media servicing system 200 illustrated in FIG. 2 is provided as an example, and other media servicing systems can omit, add, and/or substitute components, depending on desired functionality. Furthermore, as indicated above, media servicing is only one application in which the data sharding techniques disclosed herein can be utilized.

In the media servicing system 200, a media file provided by one or more media providers 230 can be processed and indexed by cloud-hosted integrated multi-node pipelining system (CHIMPS) 210. The media file may be stored on media file delivery service provider (MFDSP) 250, such as a content delivery network, media streaming service provider, cloud data services provider, or other third-party media file delivery service provider. Additionally or alternatively, the CHIMPS 210 may also be adapted to store the media file.

A content owner 220 can utilize one or more media provider(s) 230 to distribute media content owned by the content owner 220. For example, a content owner 220 could be a movie studio that licenses distribution of certain media through various media providers 230 such as television networks, Internet media streaming websites and other on-demand media providers, media conglomerates, and the like. One or more ad network(s) 260 may also be used provide advertisements, which can be shown at certain times before, after, and/or during playback of the media file.

The CHIMPS 210 can further manage the processing and syndication of media received from the media provider(s) 230. For example, the CHIMPS 210 can provide transcoding and other services to enable media provided by the media provider(s) to be distributed in a variety of formats to a variety of different device types in a variety of locations. Additionally, it can be noted that various functions, operations, processes, or other aspects that are described in this example, and other examples, as being performed by or attributable to the CHIMPS 210 can be performed by another system operating in conjunction with the CHIMPS 210, loosely or tightly synchronized with the CHIMPS 210, or independently; for example, collecting data from other digital services to be combined and reported with data collected by the CHIMPS 210 can, in some implementations, be performed by a system other than the CHIMPS 210. Additional detail regarding the functionality of the CHIMPS 210 can be found in in U.S. patent application Ser. No. 23/624,029, entitled “Dynamic Chunking for Delivery Instances,” which is incorporated by reference herein in its entirety.

In some embodiments, the CHIMPS 210 is able to gather and provide analytical data to the media provider(s) 230 and/or content owner 220 regarding the media's syndication, including user behavior during media playback. For example, the CHIMPS 210 can provide information indicating that end users tend to stop watching a video at a certain point in playback, or that users tended to follow links associated with certain advertisements displayed during playback. With this data, media provider(s) 230 can adjust factors such as media content, advertisement placement and content, etc., to increase revenue associated with the media content and provide the end user device 240 with a more desirable playback experience.

Although only one client 245 and one end user device 240 are shown in FIG. 2, it will be understood that the media servicing system 200 can provide media to many (hundreds, thousands, millions, etc.) clients 245 and end user devices 240. Moreover, the media servicing system 200 can be configured to provide the many (hundreds, thousands, millions, etc.) media assets to any or all of the clients 245. Accordingly, to effectively store and manage the vast amount of resulting analytical data, the CHIMPS 210 may utilize data sharding and/or other big data solutions. Here, however, because of the large variety different media provider(s) 230 and/or other requesting entities, the previously-described customized sharding solutions may not provide sufficient flexibility to adapt to the needs of the requesting entities. With this in mind, embodiments herein are directed to a shard arbiter that can be utilized to provide a flexible sharding solution.

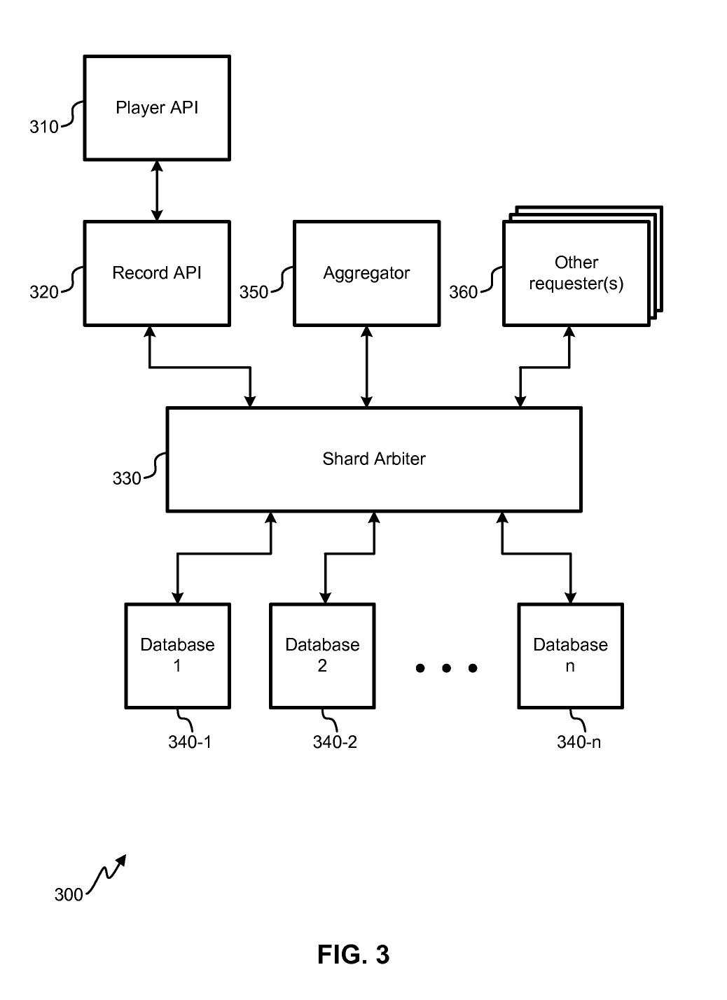

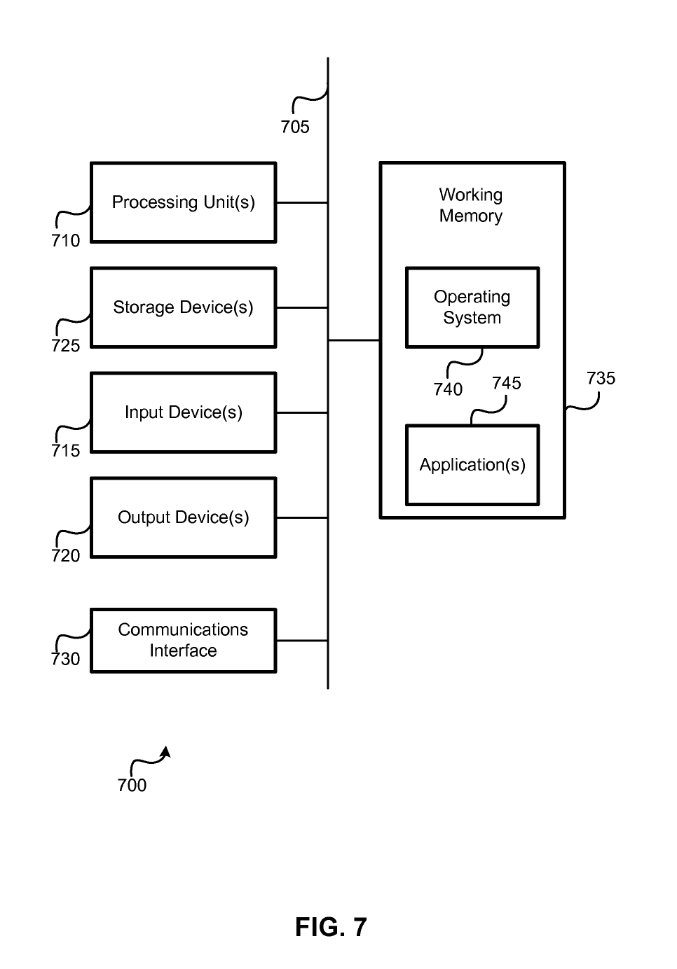

FIG. 3 is a simplified block diagram of a sharding system 300 utilizing a shard arbiter 330, described in more detail below. In this embodiment, in addition to the shard arbiter 330, the sharding system includes a player application programming interface (API) 310, record API 320, aggregator 350, other requester(s) 360, and a plurality of databases. Other embodiments may include other components, depending on the application and desired functionality. Components may be implemented using hardware and/or software on one or more computing devices, such as one or more servers of the CHIMPS 210 of FIG. 2. These computing devices can include the computer system 700 of FIG. 7, described below. Components may be combined, separated, substituted, omitted, and/or added, as needed. Databases 340 may be local to and/or remote from the shard arbiter 303. Moreover, one or more databases 340 may by hosed by a requesting entity, such as a media provider 230. A person of ordinary skill in the art will recognize various modifications.

The player API 310 can perform any of a variety of functions, depending on desired functionality. In some embodiments, the player API 310 provides media chunks and/or other information to clients 245 related to the playback of media files. The player API 310 can also gather analytics data based on the delivery of this information and/or information transmitted from the clients 245. The player API 310 can then store the analytics data on a local directory.

The player API 310 can then, periodically and/or based on a triggering event and/or schedule, post the stored analytics data. Data can be preliminarily sorted by, for example, a media provider 230 or other requesting entity, and provided to the record API 320. In one embodiment, the player API 310 posts media provider-specific JavaScript Object Notation (JSON) files to the record API 320.

The record API 320 then receives the analytics data from the player API 310 and routes the data accordingly. When the analytics data is to be stored in at least one of the databases 340, the record API 320 can provide the data to the shard arbiter 330. In addition to the data, the record API 320 can provide the shard arbiter 330 with metadata, such as a key and/or some other identifier by the shard arbiter 330 can use to identify and shard the data into the separate databases 340, providing each database 340 with its respective shard of data using the appropriate language of that particular database 340.

Periodically and/or based on a triggering event and/or schedule, the aggregator 350 can aggregate data stored in the databases 340 into a summary across different parameters, according to desired functionality. The aggregator 350 can utilize the shard arbiter 330 to aggregate data, for example, for a particular media provider 230. To do so, the aggregator 350 can provide the shard arbiter with a query in a database language (e.g., SQL) to summarize the data for that particular media provider 230 in accordance with desired parameters for the summary. Additionally, the aggregator 350 can provide the shard arbiter 330 with logic by which the shard arbiter 330 can create one or more data objects for the aggregator 350. Thus, after receiving the query and logic from the aggregator 350, the shard arbiter 330 can use the query to determine the desired data and identify the databases in which the data is stored. The shard arbiter 330 can then query the different respective databases 340 to gather the desired data, then group the data into one or more data objects for the aggregator 350 based on the logic provided by the aggregator 350.

In sum, the shard arbiter 330 can act as the arbiter for how any data is stored and queried across the databases 340. The aggregator 350 can, for example, use the shard arbiter 330 to store the summarized data it received from the shard arbiter. (When storing the summarized data, as with other data, the shard arbiter 330 may not need to parse the data into different shards. That is, only one shard may be needed.) Other requester(s) 360, which can include applications internal and/or external to the CHIMPS 210, can use the shard arbiter to retrieve data for reporting analytical data to the media provider(s) 230 and/or other entities.

Because the shard arbiter 330 acts as an intermediary between the databases 340 and the record API 320, aggregator 350, and other requester(s) 360, the record API 320, aggregator 350, and other requester(s) 360 do not need to have any knowledge of the database structure. Thus, as databases 340 are added, updated, or removed, the record API 320, aggregator 350, and other requester(s) 360 to not need to be reprogrammed to accommodate the database changes.

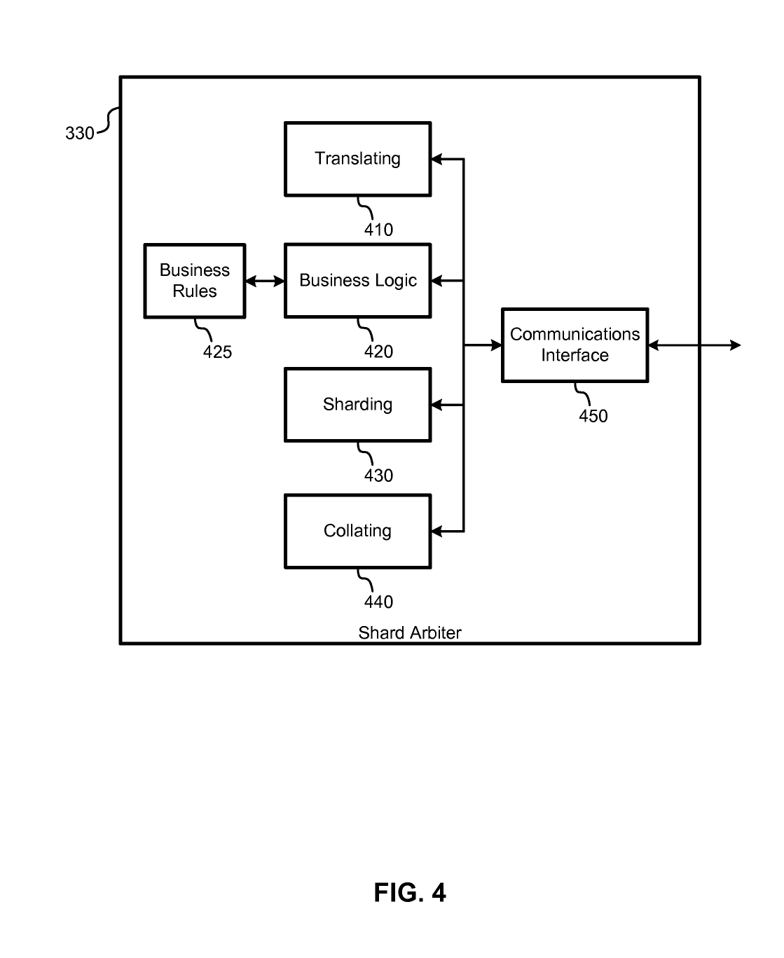

FIG. 4 is a functional block diagram of the shard arbiter 330 illustrating various functional features of the shard arbiter 330. Again, the shard arbiter 330 can be implemented in software and/or hardware of a computer system, such as the computer system 700 described in relation to FIG. 7. As with other figures provided herein, FIG. 4 is provided only as an example embodiment. Other embodiments of a shard arbiter may include different functions, based on application.

The shard arbiter 330 can include translating 410, sharding 430, and collating 440 functions, each of which can be informed by business logic 420, which is based on certain business rules 425. Thus, when the shard arbiter 330 receives a request, such as a data insert or query, it can use the business logic 420 to determine how to handle the request.

The business logic 420 can be based on metadata provided with requests. The metadata can include, for example, a customer identifier, a time of day, a type of data, and the like. Business rules can dictate how the request is to be processed, given the metadata provided, which can inform the various functions of the shard arbiter 330. For example, the business rules can include one or more connection strings indicating the database(s) to which data is to be queried and/or inserted if the business rules are satisfied.

In a further example, sharding 430 can be based on a business rule indicating data for a certain customer of a certain type is to be sharded into certain databases 340. Collating 440 can perform the same in reverse by combining data from different databases based on business rules indicating how the data was sharded. The shard arbiter 330 can receive and respond to requests from various entities via the communications interface 450.

Translating 410 is also based on how data is sharded. Here, translating 410 can comprise receiving a query and determining how the relevant data is sharded. The shard arbiter 330 can then formulate queries to the relevant databases based on the query received, translating the queries when necessary into the language used by each of the relevant databases. For example, the shard arbiter may receive a query in SQL for data that is stored in different types of databases (e.g., NoSQL, MySQL, etc.) that may utilize different query languages. Accordingly, the shard arbiter 330 will translate the SQL query as needed to provide a query to each relevant database in its respective language. Furthermore, some “translating” may be needed even when an output query is in the same language as an input query, because the query may need to be formulated differently, based on how the data is sharded. The input query may comprise any of a variety of query languages. The language of the input query can be determined by business rules (e.g., customer A uses query language B), using an identifier in the metadata, and/or parsing the query itself Similar translating can be performed on database commands other than queries.

As an illustrative example in which the sharding system 300 is part of a CHIMPS 210, the player API 310 can receive vast amounts of data regarding the playback of various media files. In particular, as end users play, pause, rewind, fast-forward, etc. through media and/or ad content, clients provide data indicative of this behavior to the player API 310 (e.g., periodically and/or on an event-triggered basis), which gathers the data and stores it in a local directory. Each piece of data is tagged with a visitor globally unique identifier (GUID), which is unique to each client 245 during the playback of a media file. Every 5 minutes, the player API posts a JSON file to the record API 320 with all the data for Broadcasting Company X (a media provider 230). The record API 320 determines the data should be routed to the shard arbiter 330, and provides the shard arbiter with the data, along with metadata indicating the data is for Broadcasting Company X and where in the data the visitor GUID can be located. The shard arbiter 330 then uses business logic 420 to shard the data based on a Business Rule Z, which dictates that data tagged with a visitor GUID beginning with numbers 0-3 is to be sent to database 1 340-1, data tagged with a visitor GUID beginning with numbers 4-7 is to be sent to database 2 340-2, and so on, such that all data is routed to a database. When the aggregator 350 subsequently sends a query to the shard arbiter 330 for summarized information for Broadcasting Company X, the shard arbiter 330 can query each of the respective databases using their respective query languages and collate the results, based on the knowledge that the data is sharded according to Business Rule Z.

Although examples above discuss the shard arbiter 330 as used in a media servicing system (e.g., as part of a CHIMPS 210), embodiments are not so limited. Techniques disclosed herein for providing a shard arbiter or similar functionality can offer sharding solutions for any of a variety of applications requiring data management.

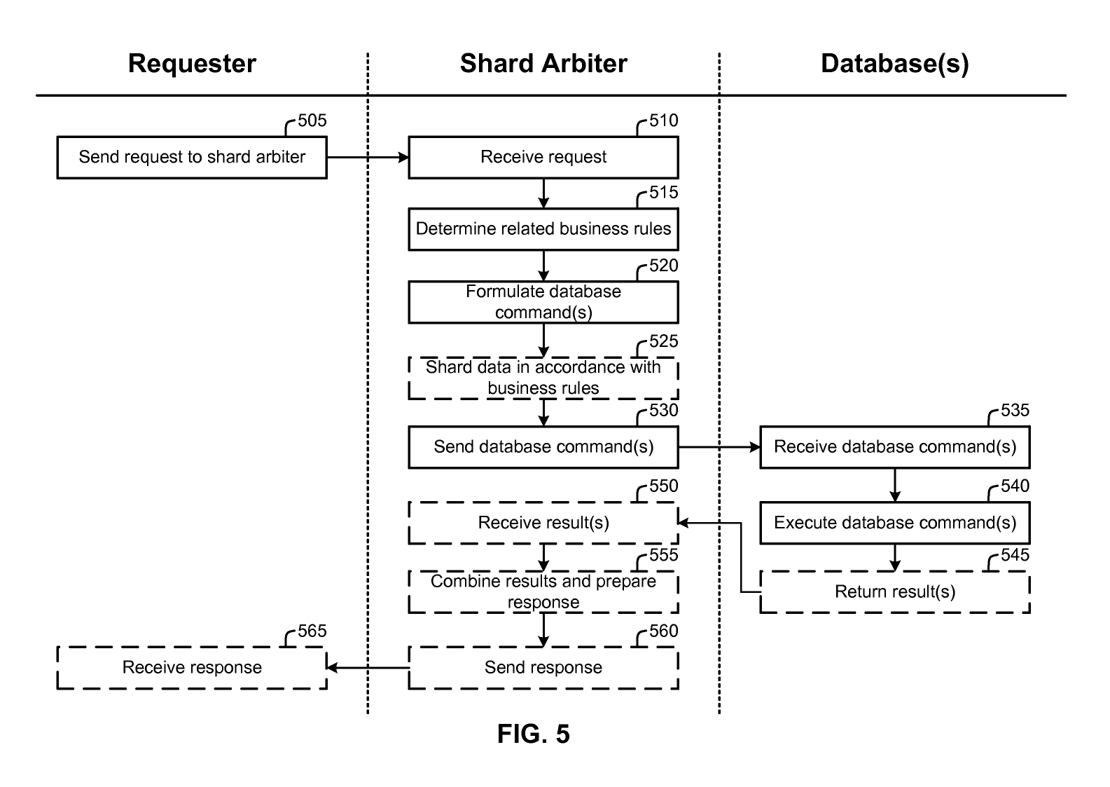

FIG. 5 is a swim-lane diagram illustrating generic interactions between a shard arbiter 330, a requester, and one or more databases 340, according to one embodiment. The shard arbiter 330, requester, and/or database(s) 340 can be configured in the manner shown in FIG. 3, for example, where the requestor can be the record API 320, Aggregator 350, and/or other requester(s) 360, and database(s) 340 can include all or a subset of the n databases 340 illustrated in FIG. 3. A person having ordinary skill in the art will recognize many alterations and modifications, which can be brought about when the shard arbiter is utilized in applications other than media servicing.

At block 505, the requestor sends a request to the shard arbiter 330. The request can include a command to be run against a database, such as a data insert and/or data query. The request can further include metadata and, for data insertion, one or more data objects. The requester can include a local application, such as an application executed by a computer in the same local network as the shard arbiter. For that matter, where the shard arbiter 330 is implemented on a single computer, the requesting application may be executed by the same computer. In other configurations, the requester may be an entity transmitting the request remotely via, for example, the Internet.

At block 510, the request is received by the shard arbiter 330, which then determines related business rules at block 515. Business rules can vary, and may be determined from the metadata provided in the request. Furthermore, business rules may be specific to a particular entity for which the data is gathered, dictating, for example, the type of database with which certain data is stored based on the entity's preferences. Additionally or alternatively, business rules can be based on any number of factors, such as database availability, data type, logic provided in the request, and the like.

At block 520, the shard arbiter 330 formulates database command(s) 520. The database command(s) can be based on the request and the database(s) involved (which can be identified based on the related business rules). Furthermore, the shard arbiter can effectively “translate” the request by formulating the database command(s) in the language(s) utilized by the database(s).

Optionally, where data is to be inserted into the database(s), the shard arbiter 330 shards the data in accordance with business rules at block 525. The sharding can be performed in any of a variety of ways, depending on desired functionality, and may not involve any virtual separation of the sharded data, but rather supplying the database(s) 340 with the portions of the data representative of its respective shard. Accordingly, sharding may be combined with block 530, in which the shard arbiter 330 sends the database command(s).

Sending database command(s) can also vary, depending on the database(s) 340 involved. Database(s) can be hosted by any of a variety of entities, such as the requesting entity. In some configurations, one or more database(s) 340 may be stored on the same computer and/or network as the shard arbiter 330. Furthermore, as indicated previously, data provided in certain requests may include only one shard, in which case the shard arbiter may send only one database command. In such a case, the shard arbiter routes the data to the correct database and provides any translating that may be needed to ensure the database command is provided in the correct querying language of the database.

At block 535, the database(s) receive the database command(s), which are executed at block 540. Depending on the type of request (e.g., a query), the database(s) 340 return result(s) at block 545.

Blocks 550-565 may be optional, depending on the type of request and/or if result(s) are to be returned to the requester. At block 550, the shard arbiter 330 receives the result(s) from the database(s) 340 and, at block 555, combines the results and prepares the response. As discussed earlier, the business rules for sharding the data can be used in reverse to determine how to results from different databases can be combined. Furthermore, the shard arbiter 330 can provide the result(s) in a preferred format of the requester. For example, the shard arbiter 330 may form one or more data objects from the result(s) using a function or other logic provided to the shard arbiter 330 by the requester in the request at block 505. The response, including the formatted result(s), is sent by the shard arbiter 330 at block 560, and received by the requester at block 565.

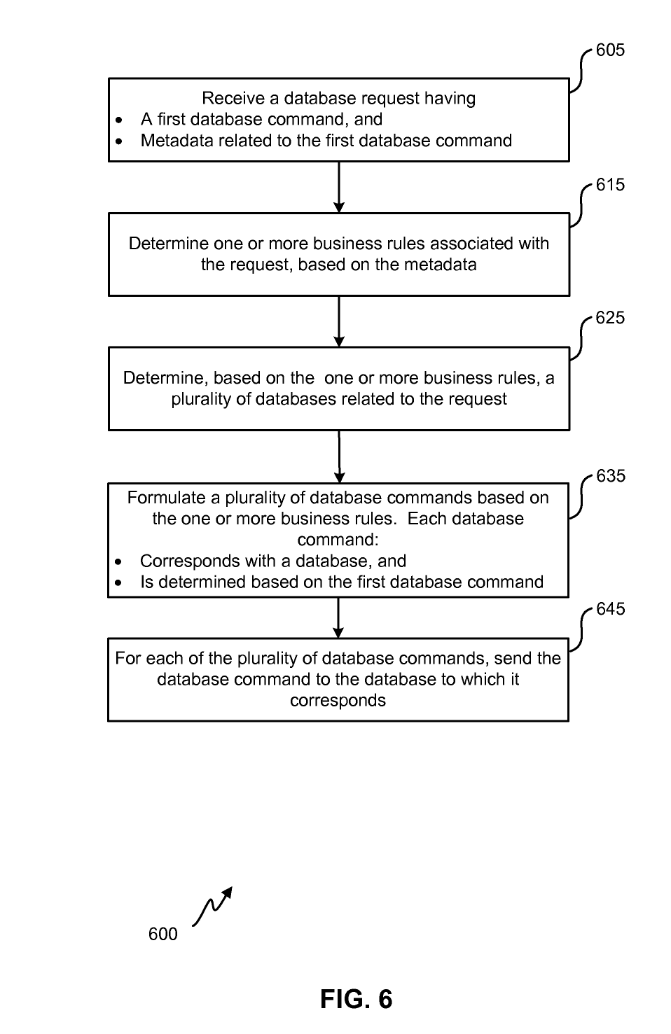

FIG. 6 is a simplified flow chart illustrating a method 600 of database request management using the techniques described herein, according to one embodiment. The method 600 can be implemented, for example, by a shard arbiter 330 as described herein above. As with all other figures provided herein, FIG. 6 is provided as an example and is not limiting. Various blocks may be combined, separated, and/or otherwise modified, depending on desired functionality. Furthermore, different blocks may be executed by different components of a system and/or different systems. Such systems can include the computer system, described herein below with regard to FIG. 7.

At block 605, a database request is received, having a first database command and metadata related to the first database command. The database command can include, for example, data insertion and/or a database query. The request can be received from any of a variety of requesting entities, as described previously.

At block 615, one or more business rules associated with the request are determined based on the metadata of the request. As indicated above, the metadata can include any type of information, such as a customer identifier, time of day, data type, and the like, which can be used to determine business rules that can be used to process the request. The business rules can be used to, at block 625, determine a plurality of databases related to the request. That is, the business rules can be used to determine how data is currently sharded and/or how data to be inserted is to be sharded. Moreover, for requests that include a data insertion, the metadata can identify a portion of the data (such as the visitor GUID in the example above) that can be used to shard the data. This identification can be made using, for example, a certain tag in the metadata.

At block 635, a plurality of database commands are formulated, based on the one or more business rules, where each command corresponds with a database and is determined based on the first database command. For example, where the first database command of the request is a query for certain data that is sharded among a plurality of databases, a plurality of corresponding database commands are formulated to retrieve the corresponding data from each database of the plurality of databases. Data insertions can be handled similarly. At block 645, for each of the plurality of database commands, the database command is sent to the database to which it corresponds, thereby inserting, retrieving, and/or otherwise manipulating the sharded data according to the request.

It should be noted that FIG. 6 provides only an example method 600 of database request management. Other embodiments may omit, substitute, or add various procedures or components as appropriate. For example, for requests in which results are provided, additional steps can be taken to retrieve, combine, and return the requested results, as indicated by the optional blocks shown in FIG. 5. A person of ordinary skill in the art will recognize many alterations to the example method 600 of FIG. 6.

FIG. 7 illustrates an embodiment of a computer system 700, which may be configured to execute various components described herein using any combination of hardware and/or software. For example, one or more computer systems 700 can be configured to execute the shard arbiter 330, database(s) 340, and/or other components of the systems described in relation to FIGS. 2-4. FIG. 7 provides a schematic illustration of one embodiment of a computer system 700 that can perform the methods provided by various other embodiments, such as the methods described in relation to FIGS. 5-6. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. In addition, it can be noted that components illustrated by FIG. 7 can be localized to a single device and/or distributed among various networked devices, which may be disposed at different physical locations.

The computer system 700 is shown comprising hardware elements that can be electrically coupled via a bus 705 (or may otherwise be in communication, as appropriate). The hardware elements may include processing unit(s) 710, which can include without limitation one or more general-purpose processors, one or more special-purpose processors (such as digital signal processors, graphics acceleration processors, and/or the like), and/or other processing structure, which can be configured to perform one or more of the methods described herein, including the methods described in relation to FIGS. 5-6, by, for example, executing commands stored in a memory. The computer system 700 also can include one or more input devices 715, which can include without limitation a mouse, a keyboard, and/or the like; and one or more output devices 720, which can include without limitation a display device, a printer, and/or the like.

The computer system 700 may further include (and/or be in communication with) one or more non-transitory storage devices 725, which can comprise, without limitation, local and/or network accessible storage. This can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 can also include a communications interface 730, which can include wireless and wired communication technologies. Accordingly, the communications interface can include a modem, a network card (wireless or wired), an infrared communication device, a wireless communication device, and/or a chipset (such as a Bluetooth™ device, an IEEE 702.11 device, an IEEE 702.15.4 device, a WiFi device, a WiMax device, cellular communication facilities, UWB interface, etc.), and/or the like. The communications interface 730 can therefore permit the computer system 700 to be exchanged with other devices and components of a network.

In many embodiments, the computer system 700 will further comprise a working memory 735, which can include a RAM or ROM device, as described above. Software elements, shown as being located within the working memory 735, can include an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above, such as the methods described in relation to FIGS. 5-6, might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 725 described above. In some cases, the storage medium might be incorporated within a computer system, such as computer system 700. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 700) to perform methods in accordance with various embodiments of the invention. According to a set of embodiments, some or all of the procedures of such methods are performed by the computer system 700 in response to processing unit(s) 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processing unit(s) 710 to perform one or more procedures of the methods described herein. Additionally or alternatively, portions of the methods described herein may be executed through specialized hardware.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A method of providing database shard arbitration among a plurality of databases, the method comprising:
receiving, via a network interface, a database request, wherein the database request comprises:
a first database command, and
metadata related to the first database command, wherein the metadata comprises information indicative of at least one of:
an entity related to the database request,
a time of day, or
a type of data;
determining one or more business rules associated with the database request, based on the metadata;
determining, based on the one or more business rules, a plurality of sharded databases related to the database request;
formulating, with a processor, a plurality of database commands based on the one or more business rules, wherein each database command of the plurality of database commands:
corresponds with a sharded database of the plurality sharded of databases,
corresponds with a separate shard of data related to the database request, and
is determined based on the first database command; and
for each database command of the plurality of database commands, sending the database command to the sharded database to which it corresponds.

2. The method of providing database shard arbitration among a plurality of databases as recited in claim 1, wherein the first database command and the plurality of database commands comprise database queries, the method further comprising:
receiving, in response to sending the database commands, results from the plurality of sharded databases;
formulating a response to the database request, wherein formulating the response comprises combining the results from the plurality of sharded databases based on the one or more business rules; and
sending the response via the network interface.

3. The method of providing database shard arbitration among a plurality of databases as recited in claim 2, wherein formulating the response further comprises creating one or more data objects with the combined results.

4. The method of providing database shard arbitration among a plurality of databases as recited in claim 1, wherein:
the database request comprises one or more data objects; and
formulating the plurality of database commands comprises including, in each database command of the plurality of database commands, a subset of the one or more data objects.

5. The method of providing database shard arbitration among a plurality of databases as recited in claim 1, wherein:
the plurality of sharded databases includes sharded databases of more than one type; and
formulating the plurality of database commands includes, for each database command of the plurality of database commands, formulating the database command in a language of the sharded database to which the database command corresponds.

6. The method of providing database shard arbitration among a plurality of databases as recited in claim 1, wherein at least one database command of the plurality of database commands is sent via the network interface.

7. (canceled)

8. A server providing database shard arbitration among a plurality of databases, the server comprising:
a communications interface;
a memory; and
a processing unit communicatively coupled with the memory and the communications interface, the processing unit configured to perform functions including:
receiving, via the communications interface, a database request, wherein the database request comprises:
a first database command, and
metadata related to the first database command, wherein the metadata comprises information indicative of at least one of:
an entity related to the database request,
a time of day, or
a type of data;
determining one or more business rules associated with the database request, based on the metadata;
determining, based on the one or more business rules, a plurality of sharded databases related to the database request;
formulating a plurality of database commands based on the one or more business rules, wherein each database command of the plurality of database commands:
corresponds with a sharded database of the plurality of sharded databases,
corresponds with a separate shard of data related to the database request, and
is determined based on the first database command; and
for each database command of the plurality of database commands, sending, via the communications interface, the database command to the sharded database to which it corresponds.

9. The server providing database shard arbitration among a plurality of databases as recited in claim 8, wherein the processing unit is further configured to perform functions including:
receiving, in response to sending the database commands, results from the plurality of sharded databases;
formulating a response to the database request, wherein formulating the response comprises combining the results from the plurality of sharded databases based on the one or more business rules; and
sending the response via the communications interface.

10. The server providing database shard arbitration among a plurality of databases as recited in claim 9, wherein the processing unit is further configured to formulate the response by creating one or more data objects with the combined results.

11. The server providing database shard arbitration among a plurality of databases as recited in claim 8, wherein the processing unit is configured to:
receive the database request comprising one or more data objects; and
formulate the plurality of database commands by including, in each database command of the plurality of database commands, a subset of the one or more data objects.

12. The server providing database shard arbitration among a plurality of databases as recited in claim 8, wherein the processing unit is configured to:
communicate with different types of sharded databases; and
for each database command of the plurality of database commands, formulate the database command in a language of the sharded database to which the database command corresponds.

13. (canceled)

14. A non-transitory computer-readable medium having instructions imbedded thereon providing database shard arbitration among a plurality of databases, the computer-readable medium including instructions for:
receiving a database request via a network interface, wherein the database request comprises:
a first database command, and
metadata related to the first database command;
determining one or more business rules associated with the database request, based on the metadata;
determining, based on the one or more business rules, a plurality sharded of databases related to the database request;
formulating a plurality of database commands based on the one or more business rules, wherein each database command of the plurality of database commands:
corresponds with a sharded database of the plurality sharded of databases,
corresponds with a separate shard of data related to the database request, and
is determined based on the first database command; and
for each database command of the plurality of database commands, sending the database command to the database to which it corresponds.

15. The non-transitory computer-readable medium having instructions imbedded thereon providing database shard arbitration among a plurality of databases as recited in claim 14, further including instructions for:
receiving, in response to sending the database commands, results from the plurality of sharded databases;
formulating a response to the database request, wherein formulating the response comprises combining the results from the plurality of sharded databases based on the one or more business rules; and
sending the response.

16. The non-transitory computer-readable medium having instructions imbedded thereon providing database shard arbitration among a plurality of databases as recited in claim 15, wherein the instructions for formulating the response comprise instructions for creating one or more data objects with the combined results.

17. The non-transitory computer-readable medium having instructions imbedded thereon providing database shard arbitration among a plurality of databases as recited in claim 14, wherein:
the database request comprises one or more data objects; and
the instructions for formulating the plurality of database commands comprise instructions for including, in each database command of the plurality of database commands, a subset of the one or more data objects.

18. The non-transitory computer-readable medium having instructions imbedded thereon providing database shard arbitration among a plurality of databases as recited in claim 14, wherein:
the plurality of sharded databases includes sharded databases of more than one type; and
the instructions for formulating the plurality of database commands includes instructions for, for each database command of the plurality of database commands, formulating the database command in a language of the sharded database to which the database command corresponds.

19. The non-transitory computer-readable medium having instructions imbedded thereon providing database shard arbitration among a plurality of databases as recited in claim 14, further including instructions for sending at least one database command of the plurality of database commands via a network interface.

20. The non-transitory computer-readable medium having instructions imbedded thereon providing database shard arbitration among a plurality of databases as recited in claim 14, further including instructions for identifying, in the metadata related to the first database command, information indicative of at least one of:
an entity related to the database request,
a time of day, or
a type of data.

21. The method of providing database shard arbitration among a plurality of databases as recited in claim 1, wherein the first database command comprises a command to insert data.
